(19) United States
(12) Patent Application Publication
(10) Pub. No.: US 2016/0069389 A1
(43) Pub. Date: Mar. 10, 2016

(54) ROLLING BODY GUIDE ELEMENT, PARTICULARLY FOR A LARGE TAPERED ROLLER BEARING

(71) Applicant: SCHAEFFLER TECHNOLOGIES AG & CO. KG, Herzogenaurach (DE)

(72) Inventors: Lorenz Bell, Erlangen (DE); Johannes Monius, Adelsdorf (DE); Roland Eichler, Herzogenaurach (DE); Manfred Jansen, Weisendorf (DE); Florian Vogelgesang, Hemhofen (DE); Sabine Plischki, Donnersdorf (DE); Manuel Rettinger, Oerlenbach (DE); Christian Seubert, Oberleichtersbach (DE); Hermann Geyer, Vestenbergsgreuth (DE); Christoph Meder, Sulzfeld (DE)

(73) Assignee: Schaeffler Technologies AG & CO. KG, Herzogenaurach (DE)

(21) Appl. No.: 14/786,764

(22) PCT Filed: Apr. 7, 2014
(86) PCT No.: PCT/DE2014/200158

§ 371 Date: Oct. 23, 2015

(30) Foreign Application Priority Data
Apr. 23, 2013 (DE) 10 2013 207 301.1

(51) Int. Cl. F16C 33/37; F16C 33/46; F16C 19/36

(52) U.S. Cl. CPC F16C 33/3706; F16C 19/364; F16C 33/4605

(57) ABSTRACT

A rolling body guide element for a roller bearing, having an inner web (1) that is arranged between two adjacent rolling bodies in the installed state and forms a first and second connecting part wall (1a, 1b) facing a respective rolling body at the radial plane of the rolling body axes, a run-on structure (2) formed in the region of the respective connecting part wall to provide at least one roller run-on zone supporting the respective rolling body in the circumferential direction, and a radial guide structure (3) for radial guidance of the inner connecting part. According to the invention, the rolling body guide element includes first and second side edge pieces (4, 5) which, on sides of the rolling body guide element facing away from one another, rise up above the end faces of the adjacent rolling body and overlap these end faces.

### BACKGROUND

### Field of the Invention

The invention is directed toward a rolling body guide element, in particular, for a large tapered roller bearing providing axial and radial support, wherein each rolling body guide element of this type is arranged between two successive rolling bodies of a roller bearing and there the two adjacent rolling bodies are supported against each other in the circumferential direction and a minimum distance is guaranteed between these rolling bodies, wherein a direct contact of the rolling bodies is prevented.

Up until now, for large tapered roller bearings in the wind power industry (diameters>2000 mm) and other fields of use of such bearing sizes, in general rolling body guide cages have been used that can be constructed as so-called pin cages or plastic segment cages. Plastic segment cages require a bearing design that is constructed, in the number of rollers, to a multiple of the rollers held in the segment. The play of the segments in the circumferential direction is difficult to control without additional variable elements due to production tolerance buildup of the individual segments. If there is increased play, there is the risk of failure due to impacts between the segments. In addition, the maximum number of rollers that can be installed is less than the number of rollers that can be installed if pin cages are used.

As an alternative to bearing constructions with cage-guided roller bearings, large roller bearings are also known that are equipped as solid rollers and thus require no cage. Solid roller bearings without cages, however, exhibit higher frictional losses and have overall a large weight. In addition, difficult lubricating conditions exist in these bearings and this leads to greater dispersion with respect to the expected service life.

From DE 2053470, a tapered roller bearing is known that comprises a bearing inner ring, a bearing outer ring, and tapered rollers that are arranged between these two bearing rings and are supported against each other by means of individual rolling body guide elements arranged between the tapered rollers. The rolling body guide elements are made from a plastic material and have, in the circumferential direction, relatively wide inner connecting parts that support or form, as such, two contact flanks.

### SUMMARY

The invention is based on the objective of providing rolling body guide element, in particular, for large tapered ball bearings, which can be produced economically and is distinguished by an advantageous mechanical operating behavior and also a long service life.

The objective mentioned above is achieved according to the invention by a rolling body guide element for a roller bearing, with:
an inner connecting part that is arranged in the installed state between two adjacent rolling bodies and forms a first or second connecting part wall turned toward the respective rolling body at the radial plane of the rolling body axes,
a run-on structure constructed in the area of each connecting part wall for preparing at least one roller run-on zone supporting the respective rolling body in the circumferential direction,
a radial guide structure for the radial guidance of the inner connecting part, and
first and second side edge parts that rise on the sides of the rolling body guide element turned away from each other above the end faces of the adjacent rolling bodies and overlap these end faces.

In this way it is advantageously possible, in a roller bearing, in particular, a large tapered roller bearing, to position the rolling body guide elements precisely in the radial and axial directions in the rolling body circulating space and to support the individual tapered rollers against each other by means of the precisely guided rolling body guide elements with little circumferential play.

The field of use of the invention is, in particular, slowly turning tapered roller bearings (rotational speeds typically <12 rpm) like those used, for example, as rotor bearings for wind turbines. The guide elements held between the rolling bodies here take over the function of the connecting rods of a rolling body guide cage and are made as injection-molded plastic parts. The guide elements separate the rolling bodies mounted in the bearing from each other and reduce the bearing friction and the bearing weight and overall increase the efficiency and service life of the corresponding bearing.

According to one especially preferred embodiment of the invention, the side edge parts are constructed such that adjacent rolling body guide elements in succession in the peripheral direction are supported one on the other by means of these side edge parts. The side edge parts then function as spacers by means of which the pocket width measured in the circumferential direction is defined precisely between two rolling body guide elements.

The radial guide structure constructed integral with the inner connecting part is shaped according to one especially preferred embodiment of the invention such that this has inner guide fingers that run onto the bearing inner ring. The guide fingers can here be provided with runner sections that slide with a smooth-running and low-wear motion, possibly with the construction of a hydrodynamic lubricant film on the respective bearing ring of the roller bearing. In particular, in combination with the measure named above, it is advantageously also possible to construct the radial guide structure so that this also has outer guide fingers that run onto the bearing outer ring. In these cases, runners that can run onto the bearing outer ring in a sliding motion are also advantageously formed on the guide fingers. The runners can be constructed so that these are supported by the formation of a hydrodynamic lubricant film during operation of the bearing in the rotational speed range typical for the design. The guide arrangement that is realized overall by the guide fingers and provides radial support can be constructed so that this comprises a total of four guide fingers that rise from the center of the inner connecting part outward in the radial direction, i.e., extending supported by the connecting part. These guide fingers can each be shaped so that these have a certain radial flexibility, so that there is not pronounced static over-determination with respect to the radial guidance of the rolling body guide element.

According to one preferred aspect of the invention, it is furthermore also possible to construct the radial guide structure such that this also fixes the axial position of the rolling body guide elements relative to the bearing inner ring and/or the bearing outer ring. For this purpose, for example, the runners of the guide fingers can be arranged so that these engage in the respective inner corner area of the rolling body guide rims of the bearing inner ring or the bearing outer ring and are thus supported axially on this area.

As an alternative to the measure named above or also in combination with this measure, it is also advantageously possible to construct, in particular, the side edge parts such that these fix the axial position of the rolling body guide elements through sliding contact of the rolling bodies. For this purpose, special run-on surfaces that can run softly onto the end faces of the respective rolling body can be formed on the side edge parts.

According to another especially preferred embodiment of the invention, each rolling body guide element is also advantageously constructed such that the inner connecting part forms, in the area of its axial ends on each side, a first and a second roller run-on zone, wherein each roller run-on zone forms a concave run-on surface arrangement engaging the run-on rolling body. The run-on surface arrangement can be constructed such that this enables a roller run-on with a certain osculation. Overall, the run-on surface arrangement is advantageously shaped so that any shearing forces that might occur in the event of unfavorable operating conditions between two adjacent rolling bodies can be transferred reliably and without exceeding critical surface pressures. The run-on surface arrangements are here advantageously constructed so that these are each constructed in pairs on opposing connecting part sides, so that the forces that might be applied to the run-on surface arrangements can be dissipated directly as purely compressive forces transverse through the connecting part cross section. The run-on surface arrangements can also be constructed so that, for an increase in the pressure load, additional wall zones of the inner connecting parts are used for transmitting supporting forces.

The inner connecting part is advantageously dimensioned so that its width measured radial to the bearing axis is greater than the distance between the outer surfaces of the rolling bodies separated by this inner connecting part. In this way it is achieved that the inner connecting part does not tilt even in the event of high crimping forces.

The rolling body guide element is produced according to a special aspect of the present invention from a plastic material. This plastic material can have a high inherent strength and is advantageously further reinforced by fillers, in particular, glass fibers. It is also possible to embed fillers or structures at least locally into the plastic material, which, as such, improve the running properties of the bearing. In particular, in the area of the run-on surfaces contacting the rolling bodies, lubricants such as graphite or MOS can be embedded. The rolling body guide element according to the invention can also be produced as an insert molding part with a core structure and an envelope structure molded onto this core structure. The core structure can be made from a plastic material or also from a sheet metal material.

The rolling body guide element according to the invention advantageously forms part of a tapered roller bearing. This tapered roller bearing advantageously comprises a bearing inner ring, a bearing outer ring, tapered rollers that are held in a roller circulating space formed between the bearing inner ring and the bearing outer ring, as well as those rolling body guide elements that are shaped according to the invention and are each held between two adjacent tapered rollers, wherein the rolling body guide elements are each equipped with side edge parts that overlap the tapered rollers in the area of their end faces and are supported against each other in the circumferential direction.

The rolling body guide elements shaped according to the invention are suitable, in particular, for use in rotor main bearings for wind turbines in the multi-megawatt range, for example, for realizing roller bearings with a diameter of approximately 4 m. In this range of output and size, up until now so-called pin cages have been used. The rolling body guide elements according to the invention allow a more economical overall solution for the relevant boundary conditions and are reliably tailored to the loads that occur and achieve the required service life with a large margin of safety.

The rolling body guide elements are advantageously made from glass-fiber-reinforced, injection-molded, media-resistant, wear-resistant thermoplastic (PEEK with glass-fiber reinforcement). In this way, tapered rollers can be used without drilling. The weight of a bearing produced with the inclusion of the rolling body guide elements according to the invention is significantly reduced in comparison with the alternatives. In an especially advantageous way, through the use of the rolling body guide elements according to the invention, the final play can be set exactly with low expense through two intermediate piece variants with different wall thicknesses in the tenth of a millimeter range through the combination of the number of variants 1 to variants 2 independent of the production tolerances.

For the rolling body guide element according to the invention, advantageously a combination of a support on the raceway is achieved with a side edge length that reaches to the roller axis. In this way, an additional axial guidance of the intermediate piece is achieved. The rolling body guide elements are installed so that two adjacent intermediate pieces just contact during operation or form a pocket play by means of the side edge parts. In this way, the run-on behavior and the operating play on the reference circle is stabilized. The roller run-on surface of the intermediate piece includes an osculation that is adapted to the roller. In this way, the surface pressure on the rolling body guide element is reduced. The support on the raceway is not in contact with the run-on surface of the roller end sides on the inner ring or outer ring. Tilting of the rolling body guide element is excluded by the shape of the run-on surfaces toward the inner and outer rings and also by the side edge surfaces. The design is optimized for the plastic injection molding process and advantageously includes no joint lines.

Two variants are provided that differ in their connecting part thickness. Thus it is possible to adjust the final play of the reference circle to a value that is not determined by the production tolerances. The invention comprises a plastic intermediate piece for large tapered roller bearings. With the invention, an economical alternative is proposed to the cost-intensive cages used until now for this size. A special design is provided that includes advantages over conventional cages for cylindrical roller bearings with regard to tilting, guidance, and friction, and is also suitable for the requirements of a tapered roller bearing that are significantly different with regard to cylindrical roller bearings. The invention is also suitable for adaptation to other large bearing constructions (e.g., swivel joint ball bearings).

### BRIEF DESCRIPTION OF THE DRAWINGS

Additional details and features of the invention can be found in the following description in connection with the drawing. Shown are:

FIG. 1 a perspective diagram of a rolling body guide element according to the invention that has a radial guide structure for the radial guidance of the inner connecting part, and also first and second side edge parts that rise on the sides of the rolling body guide element facing away from each other above the end faces of the adjacent rolling bodies and overlap these end faces,

FIG. 2 an axial section diagram for illustrating the construction of a tapered roller bearing formed with the inclusion of the rolling body guide element according to the invention,

FIG. 3 a side view of the rolling body guide element according to FIGS. 1 and 2, in particular, for illustrating the arrangement of the guide fingers guiding in the radial and also axial directions,

FIG. 4 a perspective diagram of a second embodiment of a rolling body guide element according to the invention that has a radial guide structure for the radial guidance of the inner connecting part, wherein this radial guide structure has guide arms that rise radially inward and outward in a fork-like shape from the inner connecting part and spread out in the circumferential direction into two guide fingers,

FIG. 5 a perspective diagram of a third embodiment of a rolling body guide element according to the invention that has a radial guide structure for the radial guidance of the inner connecting part, wherein this radial guide structure has a pair of guide runners oriented in the circumferential direction.

### DETAILED DESCRIPTION OF THE PREFERRED EMBODIMENTS

The diagram according to FIG. 1 shows a rolling body guide element according to the invention for a larger roller bearing constructed as a tapered roller bearing. The rolling body guide element comprises an inner connecting part 1 that is arranged in the installed state between two adjacent rolling bodies and forms a first or second connecting part wall 1a, 1b turned toward the respective rolling body at the radial plane of the rolling body axes. Furthermore, the rolling body guide element comprises a run-on structure 2 constructed in the area of the respective connecting part wall 1a, 1b for preparing at least one roller run-on zone 2a, 2b supporting the respective rolling bodies in the circumferential direction.

The radial and axial guidance of the rolling body guide element is realized by special integral guide bodies formed by this element. For example, the rolling body guide element comprises a special radial guide structure 3, for the radial guidance of the inner connecting part 1, and also first and second side edge parts 4, 5 that rise on the sides of the rolling body guide element turned away from each other above the end faces of the adjacent rolling bodies and overlap these end faces.

The side edge parts 4, 5 are constructed such that, in the installed state, the rolling body guide elements adjacent in succession in the circumferential direction are supported by means of these side edge parts 4, 5. On the side edge parts 4, 5, support surfaces 4a, 5a are formed by means of which the adjacent side edge parts 4, 5 form an area contact. The side edge parts 4, 5 are formed overall so that they function as spacers that define the pocket width measured in the circumferential direction between two rolling body guide elements.

The already mentioned radial guide structure 3 supporting the rolling body guide element in the radial direction is shaped so that this has inner guide fingers 3a that run onto the bearing inner ring in the installed state. In addition, the radial guide structure also has outer guide fingers 3b that run onto the bearing outer ring. The radial guide structure 3 is constructed in the embodiment shown here such that this also defines the axial position of the rolling body guide element relative to the bearing inner ring and/or the bearing outer ring. This will be explained in more detail in connection with the diagram according to FIG. 4.

The side edge parts 4, 5 are constructed such that these define the axial position of the rolling body guide element relative to the rolling bodies. The side edge parts 4, 5 here form a run-on sliding surface 4b, 5b turned toward the rolling body in the installed state. Overall, the distance between the opposing run-on sliding surfaces 4b, 5b is dimensioned such that each rolling body sits between these run-on sliding surfaces 4b, 5b with slight axial play.

The inner connecting part 1 is shaped such that the roller run-on structures 2 each extend in the area of its axial ends, wherein each roller run-on structure 2 forms a concave run-on surface arrangement engaging the rolling body with a pronounced osculation.

The rolling body guide element is made from a plastic material. The radially guiding guide fingers 3a, 3b are shaped so that these have a certain radial flexibility. The guide fingers 3a, 3b extend outward in a fork-like shape from the inner area of the inner connecting part 1 as can be seen in the diagram. The guide fingers 3a, 3b are produced as skeleton structures and each have a pocket that is open toward the adjacent bearing ring. In a section between the raceway contact surfaces 3c of the guide fingers 3a, 3b and the section of the inner connecting part penetrating to the side parts 4, 5, fork spaces G1, G2, G3, G4 remain in which the end sections of the guide fingers 3a, 3b can extend elastically. The guide fingers 3a, 3b are radially flexible in this extent. In the axial center area of the rolling body guide element, the inner connecting part 1 has a rectangular cross section, wherein its height h measured radial to the bearing axis is greater than its width b measured in the circumferential or circulating direction. The cross section Q of the inner connecting part 1 can also be shaped so that these connecting part wall surfaces 1a, 1b appear as at least weakly concave grooves.

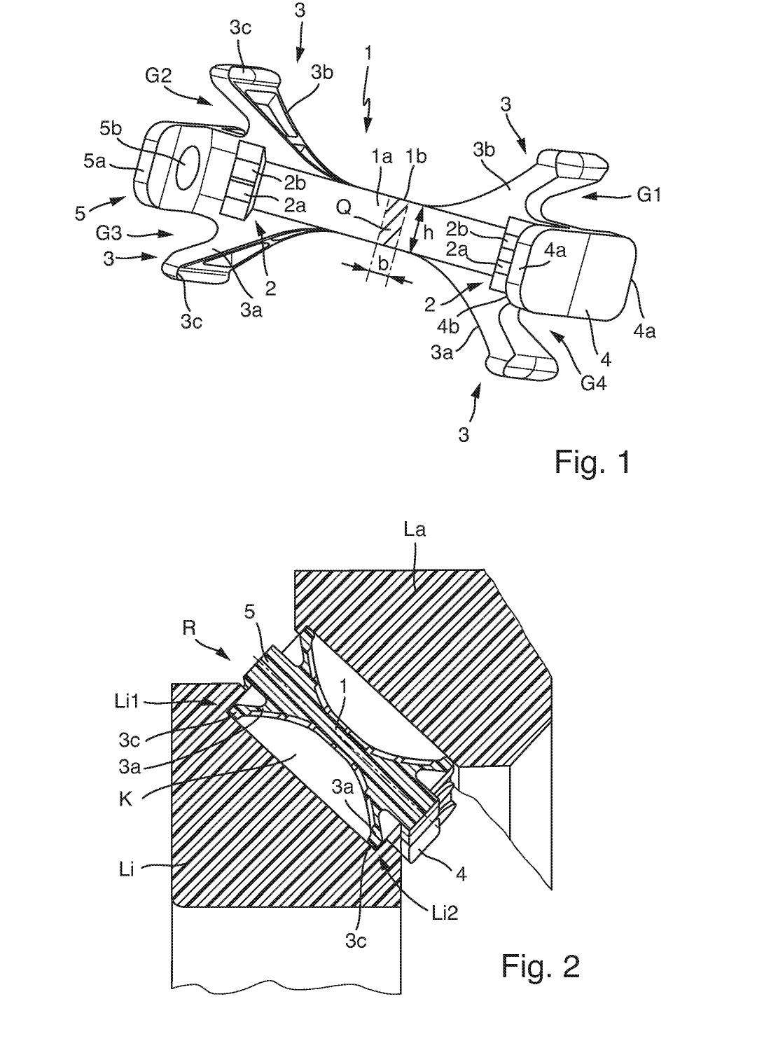

The rolling body guide element according to the invention is used in a tapered roller bearing, in particular, a large tapered roller bearing sketched in FIG. 2. This tapered roller bearing comprises a bearing inner ring Li, a bearing outer ring La, and also tapered rollers K that are held in a roller circulating space R formed between the bearing inner ring Li and the bearing outer ring La. The tapered roller bearing comprises several rolling body guide elements that are produced as separate insert elements and are each held between two adjacent tapered rollers K.

The rolling body guide elements are each equipped, as already described in connection with FIG. 1, with side edge parts 4, 5 that overlap the tapered rollers K in the area of the end faces of these rollers and are also contacted and supported opposite each other in the circumferential direction.

The positioning of the rolling body guide elements in the track space R is caused, in the normal operation, by the rolling bodies K that contact the run-on zones of the inner connecting parts 1 not shown in more detail here. In addition, by means of the side parts 4, 5 and the guide fingers 3a, the axial positioning of the rolling body guide elements is also realized. For this purpose, on one side the inner surfaces of the side parts 4, 5 run on the end sides of the tapered rollers K and, on the other side, the guide flanks 3c of the guide fingers 3a also engage in the inner corner area Li1, Li2 bordering the raceway of the bearing inner ring Li.

The circumferential play of the rolling bodies K supported by means of the individual rolling body guide elements can be adjusted in that, for example, two variants of the rolling body guide elements are produced with slightly different support thicknesses. According to the installation situation, thin and thick rolling body guide elements are then inserted in the most equal division possible.

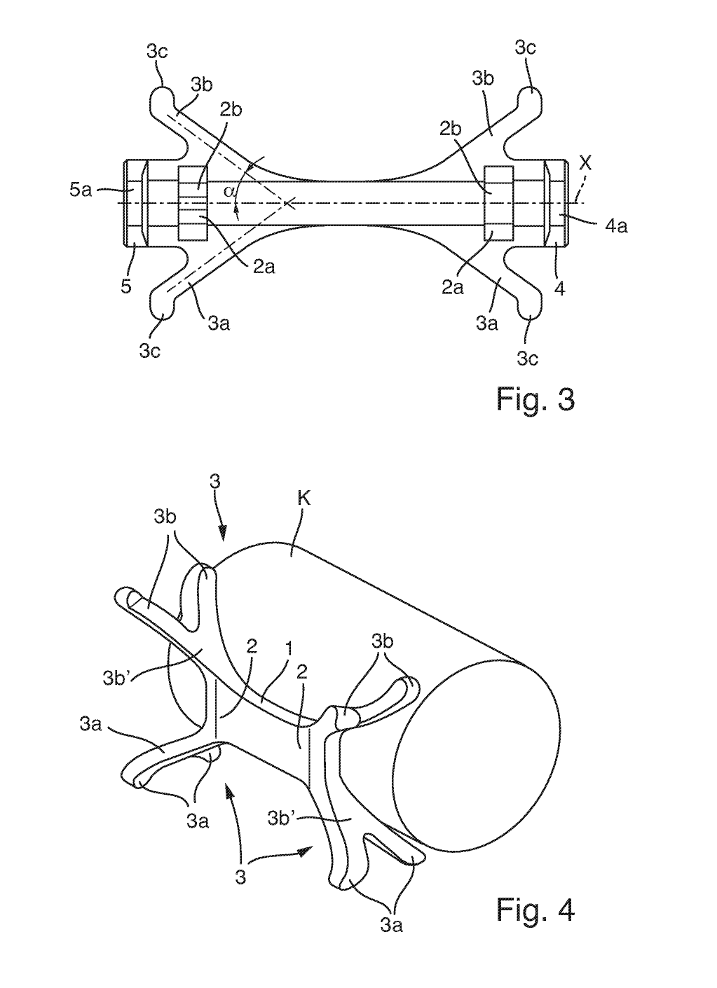

In FIG. 3, in the form of a top view, the construction of a rolling body guide element according to the invention is further illustrated. As can be seen, the radially guiding guide fingers 3a, 3b project outward while forming a fork-like structure. The radially supporting sliding contact zones 3c of the guide fingers 3a, 3b running onto the bearing inner ring or the bearing outer ring are located at the axial plane of the end areas of the tapered rollers. The setting angle α of the guide fingers 3a, 3b relative to the center axis X of the inner connecting part is in the range from 30 to 60°, here actually at 40°. The run-on zones 2a, 2b supporting the tapered rollers in the circumferential direction are also located close to the axial end area of the tapered rollers or in close proximity to the side parts 4, 5. These run-on zones 2a, 2b form a concave roller run-on with osculation. This roller run-on causes an automatic radial positioning of the rolling body guide element, at least when this supports two adjacent rollers bodies against each other without play in the circumferential direction. However, as long as the inner connecting part sits without loading between the rolling bodies, a precise radial positioning is realized by the effect of the guide fingers 3a, 3b that contact the bearing inner ring or the bearing outer ring via their runner-like guide flanks 3c. By the use of the side parts 4, 5, the axial position of the rolling body guide elements is also defined in that these side parts 4, 5 can contact the rolling body end sides with their inner sides turned toward the rolling bodies.

The positioning of the rolling body guide elements according to the invention in the circulating track space of the rolling bodies of a large tapered roller bearing is thus achieved with a certain redundancy and a certain static over-determination through multiple guide systems. The radial position is thus achieved by the “inclined” guide fingers 3a, 3b projecting like a fork from the inner connecting part, and also by the reaction forces on the run-on zones 2a, 2b. The axial positioning is caused by the side parts and the guide fingers 3a engaging in the inner corner area of the bearing inner ring. In addition, successive rolling body guide elements are supported by means of the end faces 4a, 5a one on the other and here ensure a minimum play of the rolling body guide pockets formed in this way.

The invention is not restricted to the embodiment described in detail here. For example, in particular the run-on zones 2a, 2b can also have a shape deviating from the construction shown here. To increase the compressive force carrying capacity, these can also form, for example, a larger contact surface in which these zones are formed with larger axial and radial extents. The run-on zones 2a, 2b can also be formed by inserts or insert parts that are inserted into corresponding pockets or receiving structures of the rolling body guide element.

In FIG. 4, a second embodiment of a rolling body guide element is shown in the form of a perspective diagram. This element comprises a radial guide structure 3 for the radial guidance of the inner connecting part 1. The radial guide structure 3 has guide arms 3a′, 3b′ that rise radially inward, i.e., toward the bearing axis, and outward, i.e., away from the bearing axis, in a fork-like shape from the inner connecting piece 1 and also spread out into two guide fingers 3a, 3b in the circumferential direction. The guide arms 3a′, 3b′ and optionally also the guide fingers 3a, 3b carried by these arms have side wall surfaces that are curved complementary to the lateral surface of the contacting rolling body K and softly contact this lateral surface with a slight osculation. The axial positioning of such rolling body guide elements K is achieved in that the end tips of the guide fingers 3a, 3b run into the inner corner areas of the running ring rims of the roller bearing running rings not shown here in more detail.

For the assembly of a tapered roller bearing according to the invention, a guide element is arranged between two adjacent tapered rollers. The running play of the tapered roller arrangement produced in this way and supported by means of the guide elements in the circumferential direction is adjusted in that two variants of guide elements that are slightly different with regard to their effective thickness measured in the circumferential direction (i.e., spacer holding effect) are used in combination such that a desired minimum running play is achieved. The thickness differences of the two guide element variants are here adapted under consideration of the tolerances to be expected for the rolling bodies and the bearing running rings. If necessary, more than two guide elements of “different thicknesses” could also be provided to achieve a desired minimum play for the most uniform division possible. These different thicknesses can be realized in that, in a corresponding plastic forming mold, the run-on zones formed on the inner connecting part are formed by a mold wall section that forms part of an insert, wherein this insert is either replaceable or can be variably positioned by means of backing elements such that the corresponding mold wall section can be shifted, so that through simple changes on the plastic mold, workpiece batches with different effective connecting part thicknesses can be produced.

The length of the inner connecting part measured in the longitudinal direction of the rolling body K is, in this embodiment, smaller than the axial length of the rolling body K. In the axial end areas of the inner connecting part, the run-on zones 2 supported distinctly in the circumferential direction, i.e., between two rolling bodies K, are formed on this part. These run-on zones 2 can also be shaped so that these have larger contact surfaces than is the case for the embodiment shown here.

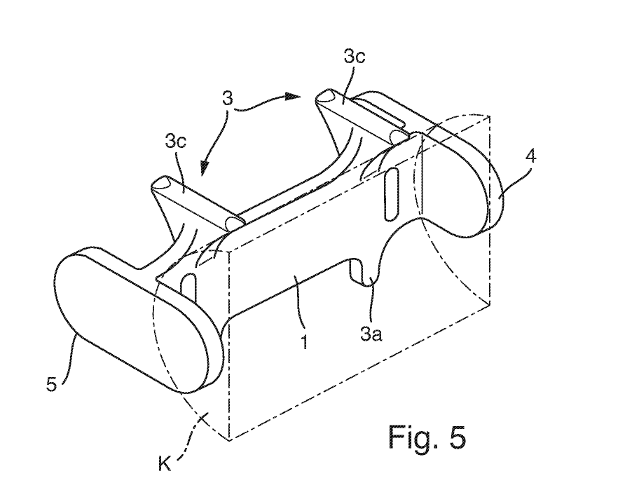

In FIG. 5, in the form of a perspective diagram, a third embodiment of a rolling body guide element is shown that has a radial guide structure 3 for the radial guidance of the inner connecting part 1, wherein this radial guide structure has a pair of guide runners 3c oriented in the circumferential direction and also radial inward guide fingers 3a, i.e., pointing toward the bearing axis. In the area of the axial ends of the inner connecting part 1, side parts 4, 5 are connected to this inner connecting part. By the use of these side parts 4, 5, the axial position of each rolling body guide element is fixed between two rolling bodies K supported by this element, in that these side parts 4, 5 can run onto the rolling body end sides with their inner sides turned toward the rolling bodies as described with respect to the embodiment according to FIG. 1. In this conception it is also possible to form the side parts 4, 5 so that the side parts contact successive rolling body guide elements and thus mutually support each other and guarantee a defined width of the produced rolling body guide pockets.

### LIST OF REFERENCE NUMBERS

1 Inner connecting part
1a Connecting part wall
1b Connecting part wall
2 Run-on structure
2a Roller run-on zone
2b Roller run-on zone
3 Radial guide structure
3a Guide finger
3b Guide finger
3a′ Guide arms
3b′ Guide arms
3c Guide flanks
4 Side edge piece
5 Side edge piece
4a End faces
5a End faces
4b Run-on sliding surface
5b Run-on sliding surface
G1 Fork space
G2 Fork space
G3 Fork space
G4 Fork space
h Height
b Width
Q Cross section
Li Bearing inner ring
La Bearing outer ring
R Roller circulating space
K Tapered rollers
Li1 Inner corner area
Li2 Inner corner area
X Center axis

1. A rolling body guide element for a roller bearing comprising:
an inner connecting part that is arranged in an installed state between two adjacent rolling bodies and forms a first or second connecting part wall turned toward the respective rolling body at a radial plane of the rolling body axes,
a run-on structure constructed in an area of the connecting part wall for preparing at least one roller run-on zone supporting the respective rolling body in a circumferential direction,
a radial guide structure for radial guidance of the inner connecting part, and
first and second side edge parts that rise on sides of the rolling body guide element turned away from each other above end faces of the adjacent rolling bodies and overlap said end faces.

2. The rolling body guide element according to claim 1, wherein the side edge parts are constructed such that adjacent ones of the rolling body guide elements in succession in the circumferential direction are supported by said side edge parts.

3. The rolling body guide element according to claim 2, wherein the side edge parts function as spacers by which a pocket width measured in the circumferential direction is fixed between two of the rolling body guide elements.

4. The rolling body guide element according to claim 1, wherein the radial guide structure has inner guide fingers that run onto a bearing inner ring.

5. The rolling body guide element according to claim 1, wherein the radial guide structure has outer guide fingers that run onto a bearing outer ring.

6. The rolling body guide element according to claim 1, wherein the radial guide structure is constructed such that it fixes an axial position of the rolling body guide elements relative to at least one of a bearing inner ring or a bearing outer ring.

7. The rolling body guide element according to claim 1, wherein the side edge parts fix an axial position of the rolling body guide elements relative to the rolling bodies.

8. The rolling body guide element according to claim 1, wherein the inner connecting part forms, in an area of axial ends thereof, on each side a first and a second roller run-on zone, and each of the roller run-on zones forms a concave run-on surface arrangement picking up the run-on rolling body.

9. The rolling body guide element according to claim 1, wherein the rolling body guide element is made from a plastic material.

10. A rolling body guide element for a roller bearing comprising:
an inner connecting part that is arranged in an installed state between two adjacent rolling bodies and forms a first or second connecting part wall turned toward the respective rolling body at a radial plane of the rolling body axes,
a run-on structure constructed in an area of the respective connecting part wall for preparing at least one roller run-on zone supporting the respective rolling body in a circumferential direction, and
a radial guide structure for radial guidance of the inner connecting part,
wherein the radial guide structure has several guide fingers that are supported by the inner connecting part and extend with a fork shape from the inner connecting part, in their profile from an attachment area on the inner connecting part toward a guide contact area lying axially at a height of axial end areas of the rolling bodies, with formation of intermediate fork spaces.

11. A tapered roller bearing, with:
a bearing inner ring,
a bearing outer ring,
tapered rollers that are held in a roller circulating space formed between the bearing inner ring and the bearing outer ring, the tapered roller have end faces,
rolling body guide elements that are produced as separate insert elements and are each held between two adjacent ones of the tapered rollers,
wherein the rolling body guide elements are each equipped with side edge parts that overlap the tapered rollers in an area of the end faces and are supported against each other in a circumferential direction.
